(19) United States
(12) Patent Application Publication
(10) Pub. No.: US 2010/0106843 A1
(43) Pub. Date: Apr. 29, 2010

(54) Communication System and its Communication Control Method

(76) Inventor: Norimasa Niiya, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/576,861

(22) Filed: Oct. 9, 2009

(30) Foreign Application Priority Data
Oct. 28, 2008 (JP) 2008-276888

(51) Int. Cl. G06F 15/16

(52) U.S. Cl. 709/228

(57) ABSTRACT

According to one embodiment, a communication system comprises a plurality of communication devices connected to a communication network. The plurality of communication devices each comprises a negotiation module and a shifting module. The negotiation module determines a CODEC to be used for a peer to peer communication by notifying a priority order of a plurality of CODECs from a transmitter side to a receiver side in negotiation prior to start of the peer to peer communication. The shifting module shifts the priority order of CODECs based on a predetermined standard to optimize a quality of the peer to peer communication.

### CROSS-REFERENCE TO RELATED APPLICATIONS

This application is based upon and claims the benefit of priority from Japanese Patent Application No. 2008-276888, filed Oct. 28, 2008, the entire contents of which are incorporated herein by reference.

### BACKGROUND

1. Field

One embodiment of the present invention relates to a telephone system which can carry out voice speech by utilizing Internet Protocol (IP) network, and its communication control method. More specifically, the present invention relates to a telephone system equipped with a function of negotiating on a utilizable CODEC method (to be abbreviated as CODEC, hereinafter) or an packet sending interval before the conversation between terminals.

2. Description of the Related Art

In many of the IP telephone systems, a session is first established between telephone terminals, and then a utilizable CODEC is determined between these terminals. This procedure is called negotiation. In the negotiation, a terminal notifies its processable CODECs to another terminal on the destination end, and vise versa. Then, based on the results, an optimal method is selected from a plurality of CODECs. When notifying CODECs, they notify to each other also the priority order of the plurality of CODECs.

In the conventional techniques, the priority order of these CODECs set for each terminal is fixed. In other words, in a negotiation, a terminal can always notify only the preset priority order to a terminal on the other side. For this reason, the priority order of CODEC which requires a wide band is high, chances are high that the CODEC requiring the wide band is selected. If a CODEC requiring a wide band is blindly selected, the occurrence of packet loss and packet delay increases when the use environment for example, the communication environment and the processability of terminals) is deteriorated. As a result, the quality of service is lowered. On the other hand, if a CODED of a narrow band (naturally, low quality) is selected, the resources cannot be effectively utilized even in a situation where the network load and CPU load are light, and therefore a quality of communication which should have been obtained cannot be achieved.

In Jpn. Pat. Appin. KOKAI Publication No. 2007-228324, the priority order of a voice CODED is associated with each combination of end point devices, and each time a call connection request is made, one voice CODEC which associated with the combination is selected. However, with such a method, it is obvious that as the number of end point devices increases, the number of combinations increases geometrically, and therefore enormous resources are consumed.

As described above, with the conventional techniques, in which the priority order of CODECs used between terminals is fixedly determined, it is not possible to select an optimal CODEC in accordance with the state of network load or CPU load. This indicates that the network resources or CPU resources (these types of resources will be called as system resources as a general term hereinafter) cannot be effectively utilized, and therefore there is a demand of some sort of countermeasures to be taken.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system diagram showing an example of the practical mode of the communication system according to the present invention;

FIG. 2 is a functional block diagram showing the embodiment of the IPT shown in FIG. 1;

FIG. 3 is a diagram showing an example of each of QoS summarization table 44a, Qos judgment result table 44b and CODEC priority order table 44c;

FIG. 4 is a flowchart showing a processing procedure of making a call to an IPT of an outgoing call origin;

FIG. 5 is a flowchart showing a processing procedure of finishing the call to the IPT of the outgoing call origin;

FIG. 6 is a diagram showing an example of the notification format used when notifying the priority order of CODECs to an incoming call destination;

FIG. 7 is a system diagram showing an example of the second embodiment of the communication system according to the present invention;

FIG. 8 is a functional block diagram showing an example of a control unit 42 and a memory 44 in the second embodiment;

FIG. 9 is a diagram showing an example of the CODEC judgment table 44d;

FIG. 10 is a system diagram showing the third embodiment of the communication system according to the present invention;

FIG. 11 is a functional block diagram showing an example of a control unit 42 and a memory 44 in the third embodiment;

FIG. 12 is a diagram showing an example of CPU load;

FIG. 13 is a functional block diagram showing an example of a control unit 42 and a memory 44 in the fourth embodiment of the present invention; and

FIG. 14 is a diagram showing an example of the time table 44e.

### DETAILED DESCRIPTION

Various embodiments according to the invention will be described hereinafter with reference to the accompanying drawings. In general, according to one embodiment of the invention, there is provided a communication system comprises a plurality of communication devices connected to a communication network. The plurality of communication devices each comprises a negotiation module and a shifting module. The negotiation module determines a CODEC to be used for a peer to peer communication by notifying a priority order of a plurality of CODECs from a transmitter side to a receiver side in negotiation prior to start of the peer to peer communication. The shifting module shifts the priority order of CODECs based on a predetermined standard to optimize a quality of the peer to peer communication.

By taking the measures, it becomes possible to dynamically change the priority order to CODECs in accordance with, for example, the network load, or the process load of the communication device (terminal). This enables effective utilization of the network resources or CPU resources, and as a result, the quality of communication can be improved. According to the present invention, it is possible to provide a communication system which can effectively utilize the system resources and also its communication control method.

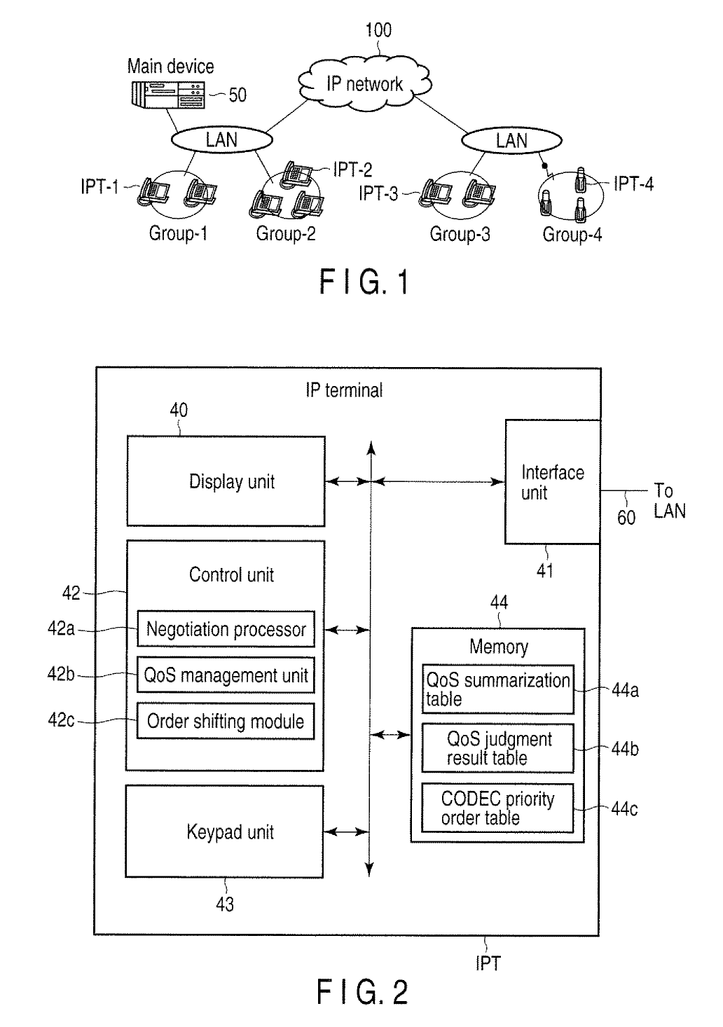

FIG. 1 is a system diagram showing an example of the practical embodiment of the communication system according to the present invention. In this example, Voice over IP, the so-called VoIP, in which voice speech is carried out via an IP network, is assumed. In this example, as the protocol for the call connecting process, Session Initiation Protocol (SIP) is assumed; however the present invention is not limited to this, but a protocol such as Media Gateway Control (Megaco) or H.323 can be utilized similarly.

In FIG. 1, a plurality of local area networks (LANs) are connected to an IP network 100, terminal devices, namely, IP terminals (IPTs) belong to each respective LAN. Of these LANs, groups of terminals of Group-1 and Group-2 belong to one of the LANs. In other words, the IPTs connected to the LANs are grouped into a plurality of groups. The following description will be made with regard to an assumed case where IPT-1 belongs to Group 1 and IPT-2 belongs to Group-2. Further, a business telephone main device (to be called as main device hereinafter) 50 is connected to the LAN to which these groups belong. The main device 50 functions as, for example, a SIP server.

To another LAN, groups of terminals of Group-3 and Group-4 belong. In this case, let us assume that IPT-3 belongs to Group 3 and IPT-4 belongs to Group-4. Note that IPT-1 to IPT-4 may not only be exclusive-use fixed telephone terminals, but also mobile communication terminals, or computers installed with telephone functions (the so-called software phones). To summarize, this embodiment presumes terminals equipped with such a function of negotiating with a terminal on the other side of the line regarding a usable CODEC with each other after establishment of a session but before starting of the conversation.

FIG. 2 is a functional block diagram showing the embodiment of the IPT shown in FIG. 1. In this example, the structure of only IPT-1 of Group 1 will be described, since the other IPT-2 to IPT-4 are also the same as IPT-1. IPT includes an interface (I/F) part 41 connected to a LAN via a LAN cable 60, a display unit 40, a control unit 42, a keypad unit 43 and a memory 44. The display unit 40 is, for example, a liquid crystal display (LCD), and displays various types messages visually. The keypad unit 43 includes soft keys, numeral keys and the like, and it receives entry operations made by the user.

The memory 44 is a rewritable semiconductor memory device such as a flash memory. The memory 44 stores in its memory region a quality of service (QoS) summarization table 44a, a QoS judgment result table 44b and a CODEC priority order table 44c. The QoS summarization table 44a, the QoS judgment result table 44b and the CODEC priority order table 44c are databases which are used solely or in combination to manage the communication quality with regard to destination sides for each CODED.

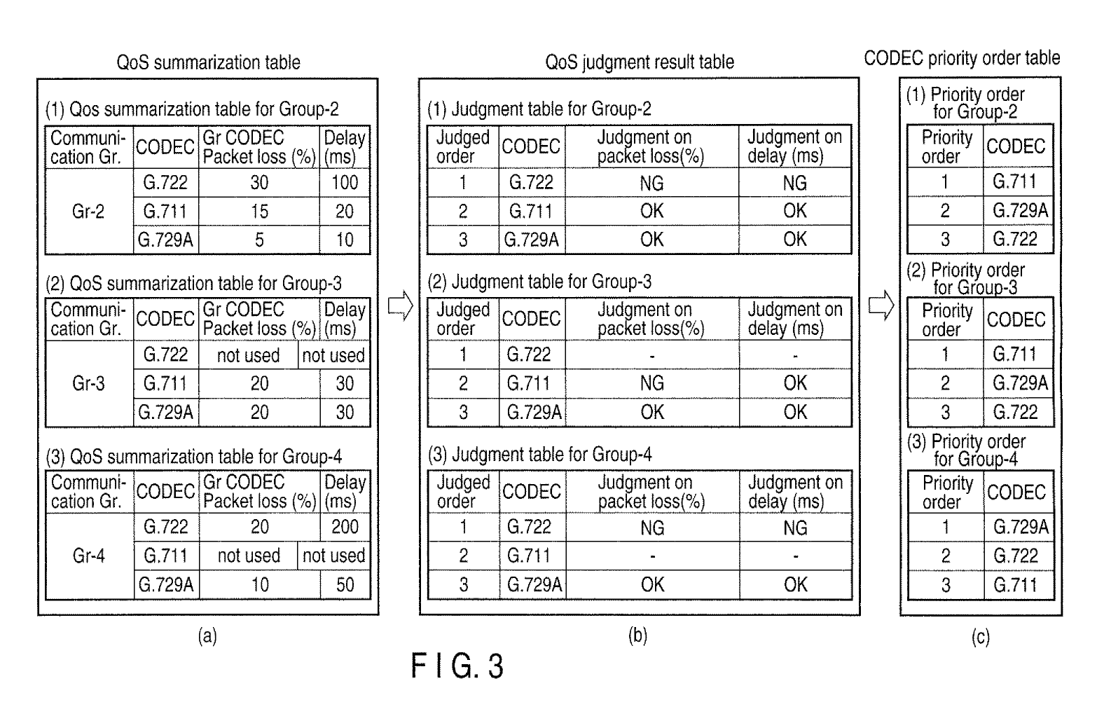

FIG. 3 shows an example of each of the QoS summarization table 44a, the QoS judgment result table 44b and the CODEC priority order table 44c. As shown in FIG. 3A, the QoS summarization table 44a manages QoS data for each CODEC used in its call history in the past judgment result table 44b and the CODEC priority order table 44c for each of the groups (Gr) of the destination sides, that is, Gr-2, Gr-2 and Gr-4. The Qos data include, for example, the packet loss rate (in unit of %) and the delay time (in unit of millisecond), both of which are values measured in each call.

The QoS judgment result table 44b is, as shown in FIG. 3B, a table which indicates the results obtained in the judgment based on a predetermined judgment standard by way of OK or NG for each item of the QoS summarization table 44a. For example, the QoS summarization table 44a indicates that in a call with a terminal of Gr-2, which utilizes G.722, the packet loss rate is 30% and the delay time is 100 milliseconds. These values were both judged to be NG by the standard, and these results are written in the QoS judgment result table 44b. Meanwhile, in another case where G.711 is used, the packet loss rate is 15%, which is written as OK in the result table 44b. The CODEC priority order table is, as shown in FIG. 3C, a table which manages the priority order of the CODECs set for each group of the call destination.

In this meantime, the control unit 42 shown also in FIG. 2 includes a negotiation processor 42a as a processing function for this embodiment, a QoS management unit 42b and an order shifting module 42c. The negotiation processor 42a notifies the priority order of the CODECs from the outgoing side to the incoming destination in the negotiation prior to the start of the peer to peer communication. Then, based on the results of the response from the incoming destination side, the CODEC to be used for the peer to peer communication is determined.

The QoS management unit 42b measures the communication quality (QoS data) for each CODEC from the history of the peer to peer communications with the incoming destinations, and summarizes the results on the QoS summarization table 44a. In this example, the QoS management unit 42b collects the QoS data of calls with IPTs belonging to each of groups shown in FIG. 1, Group-2, Group-3 and Group-4, and accumulates the results on the QoS summarization table 44a.

The order shifting module 42c shifts the priority order of the CODECs, which are originally fixed in negotiations, under a predetermined standard in order to optimize the quality of the peer to peer communication. During this operation, the order shifting module 42c shifts the priority order of the CODECs with reference to while referring to the QoS summarization table 44a and also, particularly the contents of the QoS judgment result table 44b, and based on the QoS data, that is, setting the priority of CODECs in the order of the cases where better QoS can be acquired. In other words, the order shifting module 42c shifts the priority order of the CODECs based on the QoS judgment result table 44b and thus updates the CODEC priority order table 44c. Next, the mode carrying out the present invention will now be described in more detail by referring to the first to fourth embodiments.

### First Embodiment

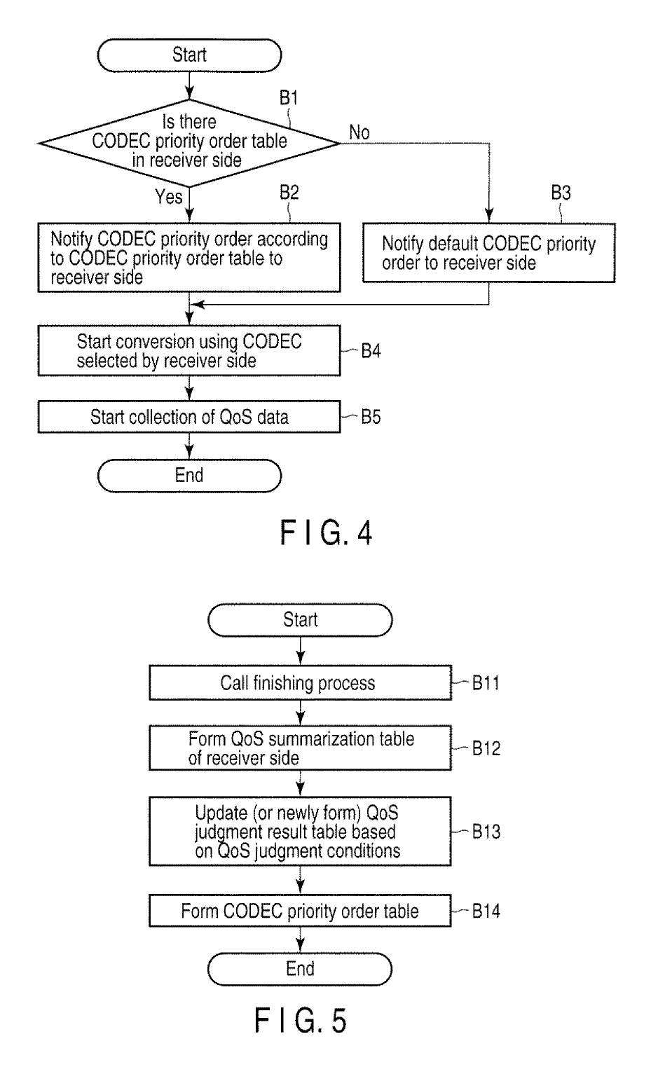

FIG. 4 is a flowchart showing a processing procedure of making a call to an IPT of an outgoing call origin. This flowchart shows a procedure of determining the priority order of CODECs when making a call from IPT-1 belonging to Group 1 to IPT belonging to another group. Upon entry of, for example, the telephone number of the incoming destination side to the use, IPT-1 starts the call connection process. First, IPT-1 judges whether or not the CODEC priority order table 44c of the destination side of the call is present in the memory 44 (Block B1). If there is no such a table, IPT-1 notifies the below-indicated default CODEC priority order to the other side of the call line (on the incoming destination side) (Block B3).

[Default Priority Order]

The first priority CODEC: G.722

The second priority CODEC: G.711

The third priority CODEC: G.729A

If the CODEC priority order table 44c is found in Block B1 IPT-1 notifies the priority order according to the CODEC priority order table 44c to the other side of the call line. For example, with reference to FIG. 3C, the CODEC priority order in connection with IPT-2 belonging to Group-2 is written in the CODEC priority order table 44c in the following procedure.

[Priority Order After Shifted]

The first priority CODEC: G.711

The second priority CODEC: G.729A

The third priority CODEC: G.722

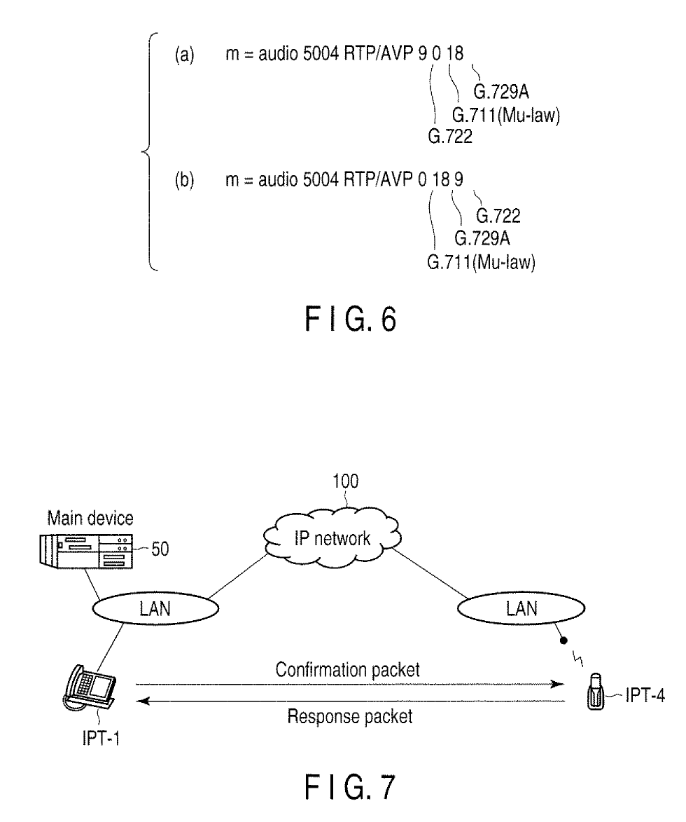

In order to notify the priority order, IPT uses such a format as shown in FIG. 6. FIG. 6 shows an example of the notification format to notify the priority order of CODECs to the destination side of the line, described in Session Description Protocol (SDP). SDP is defined as a format to describe the contents of a multi-media session in RFC 2327, and it is employed in many signaling protocols such as SIP and Megaco.

FIG. 6A is a format to notify the [Default Priority Order], and it shows that the priority order lowers in the order of G.722, G.711 and G.729A. FIG. 65 is a format to notify the [Priority Order after Shifted] and it shows that the priority order lowers in the order of G.711, G.729A and G.722.

As shown in FIG. 4, the other side of the line who received the priority order notified in such a format as shown in FIG. 6 selects the CODEC with the highest priority order of the CODECs supported by its terminal itself (that is, the terminal on the incoming side which receives the notification), and notifies the result to IPT-1. Upon reception of this notification, IPT-1 starts the conversion by using the CODEC selected by the terminal of the destination side (Block B4). Through the above-described procedure, a CODEC to be used for the peer to peer communication for this time is determined, and the conversation is started. Following this, IPT-1 starts to collect the QoS data (Block B5).

FIG. 5 is a flowchart showing a processing procedure of finishing the call to the IPT of the outgoing call origin. When the conversation is finished (Block B11), IPT-1 summarizes the collected QoS data, and forms the QoS summarization table 44a of the destination side (Block B12). Subsequently, IPT-1 imparts OK or NG to a CODEC in accordance with the QoS judgment condition, and updates the QoS judgment result table 44b. In the case where the terminal of the destination side is the first to make a call to, the QoS judgment result table 44b is newly formed (Block B13). Next, IPT-1 shifts the priority order of CODECs according to the QoS judgment result table 44b, and forms (or updates) the CODEC priority order table 44c (Block B14).

As described above, this embodiment is an IP telephone system equipped with a function of selecting and determining a CODEC used in the communication by the negotiation between terminals prior to the conversation. In this system, QoS data is collected for each of calls, and the results are associated with the terminal of the destination side for each CODEC, and accumulated in the memory 44. With reference to the contents accumulated, the priority order of CODECS is shifted so as to acquire best possible QoS, and it is transmitted to another terminal of the destination in the next negotiation.

With the above-described structure, it becomes possible to dynamically change the priority order of CODECS based on the measured QoS with the main objective to improve the QoS. Consequently, the network resources or CPU resources can be utilized even more effectively, and therefore the quality of communication can be improved. As a result, it becomes possible to provide a communication system which can effectively utilize the system resources as well as its communication control method.

### Second Embodiment

FIG. 7 is a system diagram showing the second embodiment of the communication system according to the present invention. FIG. 7 shows a system structure similar to that of FIG. 1, but in the second embodiment, it is not always necessary to divide IPTs into groups.

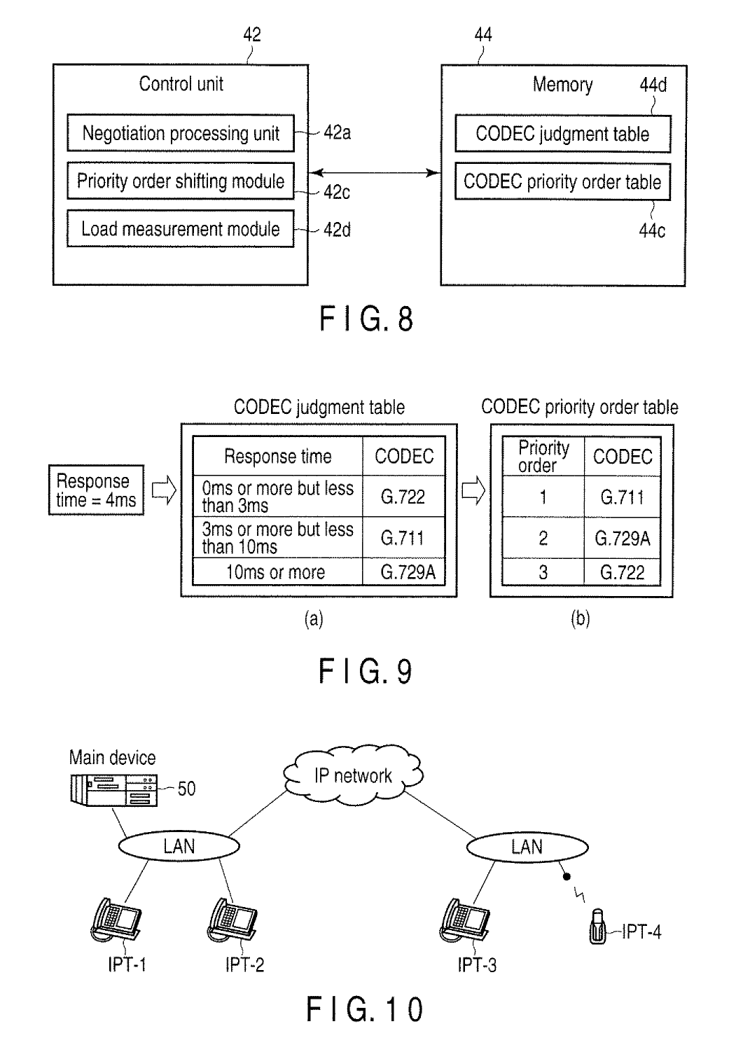

FIG. 8 is a functional block diagram showing an example of a control unit 42 and a memory 44 in the second embodiment. In the second embodiment, the control unit 42 is provided with a load measurement module 42d serving as its processing function, and the memory 44 stores a CODEC judgment table 44d.

The load measurement module 42d measures the transmission load on an IP network 100 for example, network load or available space for the network band, etc.). More specifically, the load measurement module 42d transmits a test confirmation packet to the IP network 100, and measures the transmission loss from the time required to receive a response therefor. For the confirmation packet, for example, keep-alive message or the like can be applied. In the second embodiment, with reference to the transmission load measured by the load measurement module 42d, the priority order shifting unit 42c shifts the priority order of CODECs. Next, the advantage obtained from this embodiment will now be discussed.

As shown in FIG. 7, IPT-1 on the outgoing origin side transmits a confirmation packet to IPT-4 on the incoming destination side before starting the conversation with IPT-4. Upon reception of the packet, IPT-4 returns a response packet to the confirmation packet to IPT-1. IPT-1 measures the response time, which is taken from the transmission of the confirmation packet to the reception of the response packet, and stores it in the memory 44.

The CODEC judgment table 44d stored in the memory 44 is a table in which the ranges of response time and CODECs to be applied are respectively associated with each other, as shown in FIG. 9A. For example, when the response time is 0 millisecond or more but 3 milliseconds or less, G.722 CODEC is applied. The example shown in FIG. 9 is based on the assumption that a response time of 4 milliseconds was measured, and in this case, the value is in the range where G.711 should be applied. Therefore, in the second embodiment, IPT-1 shifts the CODECs such that the priority order of G.711 is the highest in the CODEC priority order table. The results will be, for example, as follow.

[Priority Order After Judgment]

The first priority CODEC: G.711

The second priority CODEC: G.729A

The third priority CODEC: G.722

In accordance with the results of judgment, IPT-1 notifies the priority order of CODECs to the terminal on the destination side by the notification format shown in FIG. 6. As described above, according to the second embodiment, it becomes possible to determine the priority order of CODECS in consideration of the load on the network. In this manner as well, QoS can be improved while optimizing the system resources.

### Third Embodiment

FIG. 10 is a system diagram showing the third embodiment of the communication system according to the present invention. FIG. 10 shows a system structure similar to that of FIG. 7.

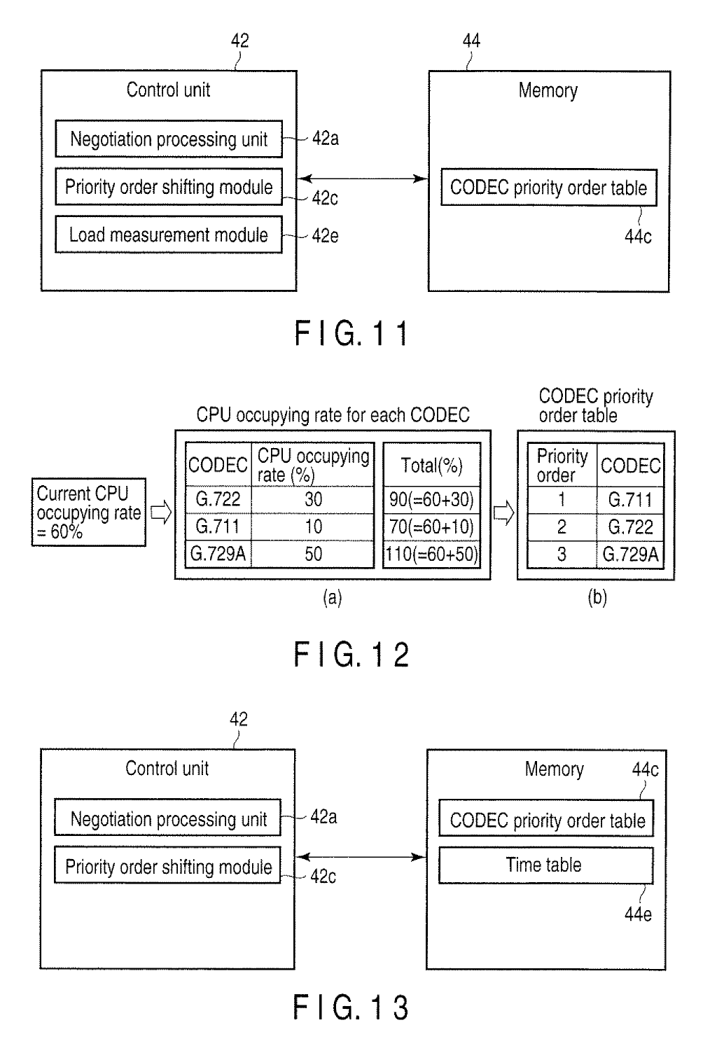

FIG. 11 is a functional block diagram showing an example of a control unit 42 and a memory 44 in the third embodiment. In the third embodiment, the control unit 42 is provided with a load monitor unit 42e serving as its processing function.

The load monitor unit 42e monitors the processing load on the terminal itself, more specifically, the load on the central processing unit (CPU), the remaining memory capacity, etc., one by one, or each time a call is made. The results are stored in the memory 44.

IPT-1, when making a call to other terminal on the destination side (in this case, IPT-4), monitors the CPU load at that time. Meanwhile, the memory 44 stores, for example, a preset table of CPU loads to be required for respective CODECs, as shown in FIG. 10A. As shown in FIG. 10, if a monitored CPU load is 60%, the CPU load required when each CODEC is applied will be obtained, for example, by simple addition as follows.

[Results of Addition of CPU Load for Each CODEC to the Present CPU Load]

G.722: 90%

G.711: 70%

G.729A: 110%

G.729A is a mode which can narrow the necessary band, but it requires a high CPU power in exchange. If this is applied, the CPU load exceeds 100% (110%), and therefore it is not practical. Under these circumstances, in this embodiment, for example, the following judgment standard is set.

[Judgment Standard]

Less than 30%: (1) G.722, (2) G.711, (3) G.729A

30% or more but less than 50%: (1) G.711, (2) G.722, (3)

50% or more: in the order of CPU occupied rate being less

In this standard ( ) indicates the priority order. In FIG. 9, the occupied rate exceeds in every CODEC, and therefore the item “in the order of CPU occupied rate being less” is selected. In accordance with this judgment standard, the priority order of CODECs will be as follows.

[Priority Order After Judgment]

The first priority CODEC: G.711

The second priority CODEC: G.722

The third priority CODEC: G.729A

In accordance with the results of judgment, IPT-1 notifies the priority order of CODECs to IPT-4 by the notification format shown in FIG. 6. As described above, according to the third embodiment, it becomes possible to determine the priority order of CODECS in consideration of the load on the IP terminal. In this manner as well, QoS can be improved while optimizing the system resources.

### Fourth Embodiment

FIG. 13 is a functional block diagram showing an example of a control unit 42 and a memory 44 in the fourth embodiment of the present invention. In the fourth embodiment, a time table 44e is stored in the memory.

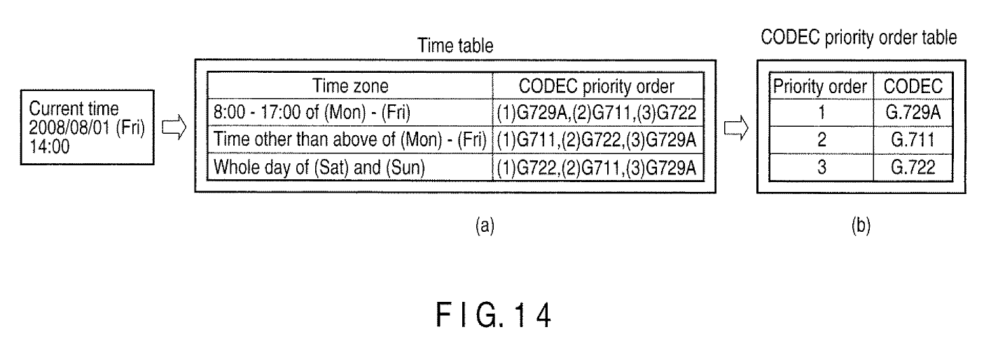

As shown in FIG. 14A, the time table 44e is a table in which the priority order of CODECs is defined for each time zone. In FIG. 14A, 3 time zones are defined for days of the week and time zones, and the priority order differs from one time zone to another. It should be noted here that a time zone may be a form which assigns the day or time, or a more moderate (or fine) standard form such as a season.

The order shifting module 42c of IPT-1 refers to the time table 44e upon negotiation, and sets the priority order which corresponds to the day and time at that point, to be notified to a terminal of the destination side. In other words, upon negotiation, IPT-1 refers to the time table 44e, and judges to what time zone the present day and time belong, thereby determining the priority order of CODECs. As shown in FIG. 14, if the day and time when the call is made is “Aug. 1, 2008 (Friday), 14:00”, it is categorized in the time zone “8:00 to 17:00 of Monday to Friday”, and the priority order of CODECs is as follows.

[Priority Order After Judgment]

The first priority CODEC: G.729A

The second priority CODEC: G.711

The third priority CODEC: G.722

In accordance with the results of judgment, IPT-1 notifies the priority order of CODECs to IPT-4 by the notification format shown in FIG. 6. As described above, according to the fourth embodiment, it becomes possible to determine the priority order of CODECS in consideration of the time zone. In this manner as well, QoS can be improved while optimizing the system resources.

It should be noted that the present invention is not limited to the above-described embodiments. For example, the process indicated in each of the first fourth embodiments can be used not only solely by each, but also in combination with other embodiment. For example, when the third and fourth embodiments are combined together, a further elaborate optimization of resources can be realized in consideration of both of the time zone and CPU load.

In the meantime, each of the embodiments focuses on the shifting of the priority order of CODECs, but the packet transmission intervals can be determined by a similar procedure. Further, the present invention is not limited to voice speech communications. As conventionally known, various types of CODEC formats, typical examples of which are MPEG2 and MPEG4, for the transmission of video signals, and a necessary band and CPU load vary diversely from one format to another. With the procedures presented in these embodiments, the resources can be optimized for such video CODEC formats as well.

Furthermore, each of the embodiments provided above describes as its principal object the “notification of the priority order of CODECS from an outgoing transmitting side to an incoming destination side”; however, in an opposite point of view, a similar technical concept can be applied for the “determination of a priority order to be selected by the destination terminal side from the CODECs notified from the transmitter side”.

Moreover, the above-provided embodiments were described in connection with examples of IP telephone systems which utilize the IP network; however, these examples can be applied to voice speech terminals which utilize the analog network. For example, a negotiation procedure similar to the above can be realized between a switched device housing an analog telephone and a calling terminal of the IP network.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication system comprising a plurality of communication devices connected to a communication network, wherein the plurality of communication devices each comprises:
a negotiation module configured to, in negotiation prior to start of a peer to peer communication, determine a CODEC to be used for the peer to peer communication by notifying a priority order of a plurality of CODECs from a transmitter side to a receiver side; and
a shifting module configured to shift the priority order of CODECs based on a predetermined standard to optimize a quality of the peer to peer communication.

2. The communication system of claim 1, wherein the shifting module shifts the priority order with reference to at least one of a day of a week and a time zone.

3. The communication system of claim 1, wherein the plurality of communication devices each further comprises:
a quality management table containing a database of communication quality with the receiver side for each of the CODECs; and
a management module configured to manage the communication quality for each of the CODECs in the quality management table from a record of peer to peer communications with the receiver side,
and wherein the shifting module shifts the priority order based on the communication quality for each of the CODECs managed in the quality management table.

4. The communication system of claim 1, wherein the plurality or communication devices each further comprises:
a measurement module configured to measure a transmission load on the communication network from a time required to receive a response to a confirmation packet sent to the communication network,
and wherein the shifting module shifts the priority order based on the transmission load.

5. The communication system of claim 1, wherein the plurality of communication devices each further comprises:
a monitor module configured to monitor a processing load of the device itself,
and wherein the shifting module shifts the priority order based on the processing load.

6. The communication system of claim 1, wherein the plurality of CODECs are each of a type relating to audio data.

7. The communication system of claim 1, wherein the plurality of CODECs are each of a type relating to video data.

8. A communication control method applied to a communication system comprising a plurality of communication devices connected to a communication network, the method comprising:
notifying a priority order of a plurality of CODECs from a transmitter side to a receiver side in a negotiation between the plurality of communication devices prior to start of a peer to peer communication;
determining a CODEC to be used for the peer to peer communication based on the notified priority order by the device of the receiver side; and
shifting the priority order of CODECs based on a predetermined standard to optimize a quality of the peer to peer communication by the device of the transmitter side.

9. The communication control method of claim 8, further comprising: shifting, by the communication device, the priority order with reference to at least one of a day of a week and a time zone.

10. The communication control method of claim 8, further comprising:
managing, by the communication device, the communication quality for each of the CODECs in the quality management table from a record of peer to peer communications with the receiver side, in a quality management table containing a database of communication quality with the receiver side for each of the CODECs; and
shifting the priority order based on the communication quality for each of the CODECs managed in the quality management table.

11. The communication control method of claim 8, further comprising:
sending a confirmation packet to the communication network;
measuring a transmission load on the communication network from a time required to receive a response to the confirmation packet; and
shifting the priority order based on the transmission load.

12. The communication control method of claim 8, further comprising:
monitoring a processing load of the device itself; and
shifting the priority order based on the processing load.

13. The communication control method of claim 8, wherein the plurality of CODECs are each of a type relating to audio data.

14. The communication control method of claim 8, wherein the plurality of CODECs are each of a type relating to video data.
